(19) United States
(12) Patent Application Publication
(10) Pub. No.: US 2002/0107749 A1
(43) Pub. Date: Aug. 8, 2002

(54) Networked based paralleling switchgear equipment configuration process

(76) Inventors: David Leslie, Wheaton, IL (US); Robert Laufenberg, Wheaton, IL (US)

Correspondence Address: John S. Beulick, Armstrong Teasdale LLP, Suite 2600, One Metropolitian Sq., St. Louis, MO, 63102, US

(21) Appl. No.: 09/777,057

(22) Filed: Feb. 5, 2001

(51) Int. Cl. G06F 17/60

(52) U.S. Cl. 705/26; 705/29

(57) ABSTRACT

In an exemplary embodiment, a network-based method for a user to automatically create a paralleling switchgear system using a product configurator system. The product configurator system is software based and resides on a server and accesses a database storing specific manufacturing requirements of the paralleling switchgear system. The user configures a paralleling switchgear system by using the product configurator to specify system information, an engine generator configuration, and a distributor breaker configuration. The user can lookup a quotation and modify it or can generate a new quotation. The product configurator generates drawings and a price quote based on the user configuration.

### BACKGROUND OF THE INVENTION

This invention relates generally to paralleling switchgear equipment and, more particularly, to a network-based method for the configuration of paralleling switchgear.

Paralleling switchgear equipment is used to control, synchronize, and switch the electrical energy generated by multiple on-site engine-generators in the process of generating electricity, and then the parallel switch gear equipment is used to distribute electricity to critical loads.

Typically when a quote for paralleling switchgear system is requested by a customer, an application engineer has to determine the customer's requirements based on a specification, develop a bill of material, and a price quote for the system. After a purchase order for the paralleling switchgear system is received, the application engineer must manually complete “order entry” documents, which are used by a design engineer to custom design the system. The design engineer reviews the specification, writes custom software for each paralleling switchgear system, and creates drawings and bills of material to manufacture the system. At the completion of manufacturing, parameters necessary to configure the system are entered into various components manually one-by-one.

After manufacturing and testing of the paralleling switchgear is complete, the design engineer manually writes a packing list, and a ship-to address is obtained from the customer. This information is manually handed to a transportation company, and the equipment is then shipped to the customer.

This method of manually configuring, quoting, designing, manufacturing, and shipping the paralleling switchgear system is inherently inaccurate because of human error when recording or transposing data. Also, since the data is manually entered into a spreadsheet or database, there is little opportunity to perform analysis on the data and, therefore, no opportunity for performing statistical process analysis. Statistical process control is known to be used to correct process defects, determine component failure, and determine required maintenance.

Previously, solutions have included developing standard specifications, drawings, and bills of material for paralleling switchgear equipment. These documents are then used as a basis for a custom design. However, this solution does not completely define the process from ordering a system to the delivery of the system. Therefore, errors maybe made during any stage of the process starting from: when the order is initially taken from a customer; providing the order information to sales; providing user specifications to engineering; supplying the engineering design to manufacturing; supplying the system to test; and shipping the system ordered to the customer.

It would be desirable to have a network based method for a user to automatically configure and order a paralleling switch gear system, develop a bill of material, provide a price quotation, and store the configuration in a central database.

### BRIEF SUMMARY OF THE INVENTION

In an exemplary embodiment of the invention, a network-based method for a user to automatically create a paralleling switchgear system using a product configurator system is provided. The product configurator system is software based and resides on a server. The product configurator accesses a database storing specific manufacturing requirements of a paralleling switchgear system. The user configures a paralleling switchgear system by using the product configurator to specify system information, an engine generator configuration, and a distribution breaker configuration when specifying the paralleling switchgear system. The user has the ability to lookup a previously entered quotation and modify it, or the user can generate a new quotation for a new paralleling switchgear system. The product configurator generates a price quote, a bill of material, and engineering drawings based on the user's configuration and accepts an order submitted by the user.

### BRIEF DESCRIPTION OF THE DRAWINGS

FIG. 1 is an exemplary embodiment of a system block diagram;

FIG. 2 is a flow diagram of a network based system for customizing a paralleling switchgear equipment system;

FIG. 3 is a process flow diagram for a user using a network based method or customizing a paralleling switchgear system, developing a bill of material, and generating a price quotation;

FIG. 4 is an exemplary embodiment of a user interface to lookup a quotation;

FIG. 5 is an exemplary embodiment of a user interface for project contact information;

FIG. 6 is an exemplary embodiment of a user interface for selecting a paralleling switchgear system configuration;

FIG. 7 is an exemplary embodiment of a user interface for selecting an engine generator for a paralleling switchgear system; and

FIG. 8 is an exemplary embodiment of a user interface for configuring a distribution breaker(s) for a paralleling switchgear system.

### DETAILED DESCRIPTION OF THE INVENTION

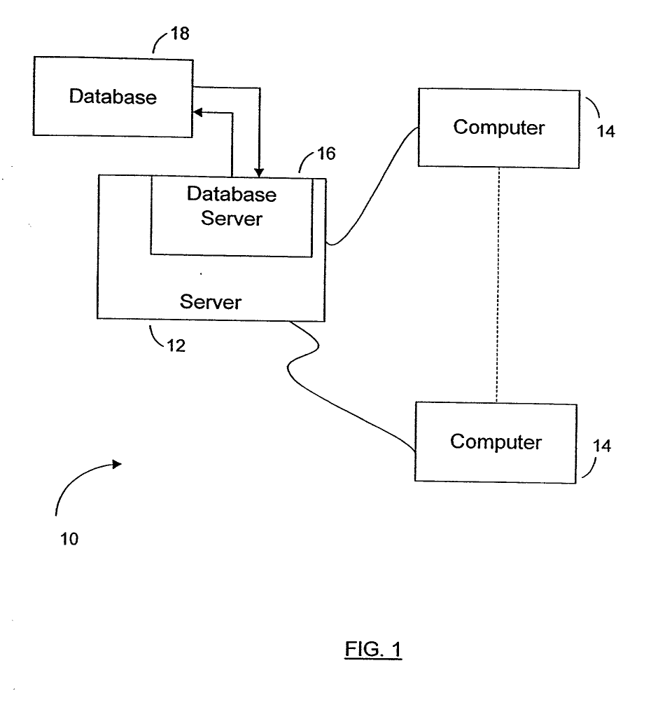

FIG. 1 is a block diagram of a system 10 in accordance with one embodiment of the present invention. System 10 includes a server sub-system 12, sometimes referred to herein as server 12, and a plurality of user devices 14 connected to server 12. In one embodiment, devices 14 are computers that include a web browser. Server 12 is accessible to devices 14 via a network, such as, an intranet or the Internet. In an alternative embodiment, devices 14 are servers for a network of customer devices.

Devices 14 are interconnected to the network, such as a local area network (“LAN”) or a wide area network (“WAN”), through many interfaces including dial-in-connections, cable modems, and high-speed ISDN lines. Alternatively, devices 14 are capable of interconnecting to a network including a network-based phone or other network-based connectable equipment. In one embodiment, the network utilizes a transmission control protocol/internet protocol (“TCP/IP”) protocol. In another embodiment, the network utilizes a internetwork packet exchange (“IPX”) protocol. Server 12 includes a database server 16 connected to a centralized database 18 containing paralleling switchgear information. Database 18 provides information on a paralleling switchgear equipment, as described below in greater detail. In one embodiment, centralized database 18 is stored on database server 16 and can be accessed by potential users utilizing one of user devices 14 by logging onto server sub-system 12 through one of user devices 14. In an alternative embodiment centralized database 18 is stored remotely from server 12.

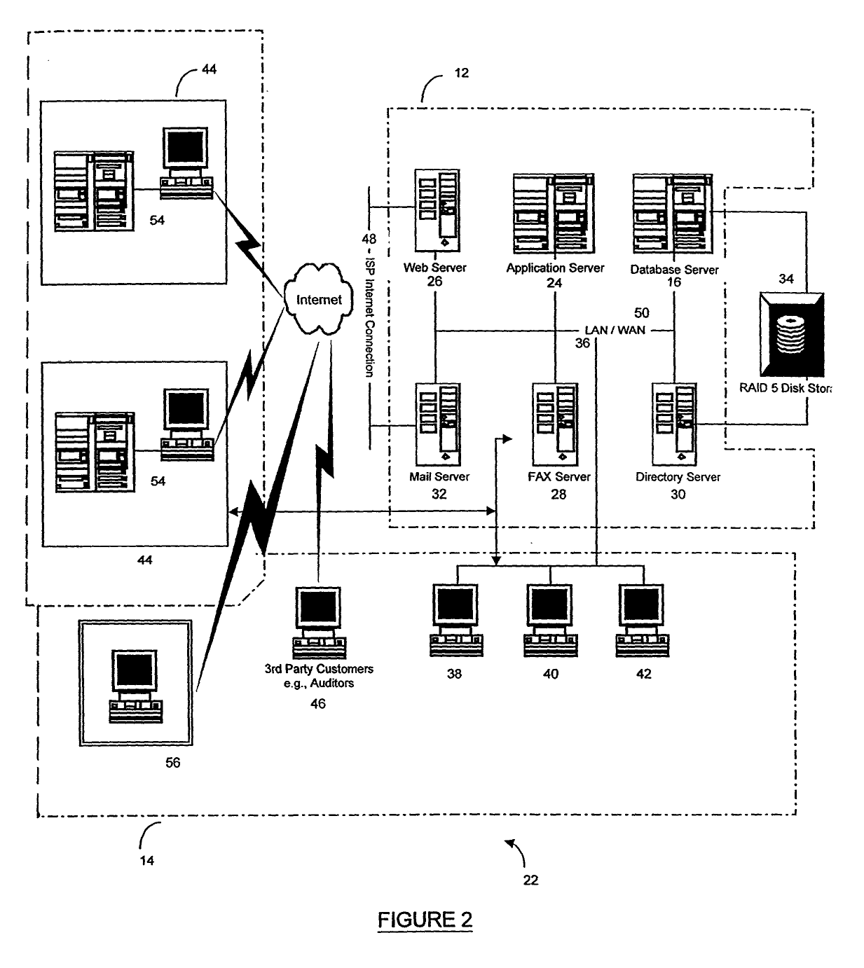

FIG. 2 is a block diagram of a network based system 22. Components of network based system 22 which are identical to the components of system 10 (shown in FIG. 1) are identified in FIG. 2 using the same reference numerals as used in FIG. 1. System 22 includes server sub-system 12 and customer devices 14. As used herein, the term server includes both a single server, as well as, interconnected distributed servers. Server sub-system 12 includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (“LAN”) 36. In addition, a system administrator work station 38, a work station 40, and a supervisor work station 42 are coupled to LAN 36. Alternatively, work stations 38, 40, and 42 are coupled to LAN 36 via an Internet link or are connected through an intranet.

Each work station 38, 40, and 42 is a personal computer including a web browser and printer capability. Although, the functions performed at the work stations typically are illustrated as being performed at respective work stations 38, 40, and 42, such functions can be performed at one of many personal computers coupled to LAN 36. Work stations 38, 40, and 42 are illustrated as being associated with separate functions only to facilitate an understanding of the different types of functions that can be performed by individuals having access to LAN 36.

Server sub-system 12 is configured to be communicatively coupled to various computers used by individuals or employees 44 and to third parties, e.g., a customer computer 46 is connected via an ISP Internet connection 48 to server sub-system 12. The exemplary embodiment illustrates communication using the Internet, however in other embodiments, other types of communications networks can be utilized, e.g., in another embodiment, a wide area network (“WAN”) 50 can be utilized. In an alternative embodiment, a LAN 36 can be utilized.

In the exemplary embodiment, any employee 44 or customer 46 having a work station can access server sub-system 12. One customer device 14 includes a work station 56 that is located at a remote location and configured to communicate with server sub-system 12. Work station 54 is a personal computer including a web browser that displays information through an HTML document downloaded by server sub-system 12. Furthermore, fax server 28 communicates with employees 44 and customers 46 located outside the business entity and any of the remotely located customer systems, including a customer system 56 via a telephone link. In addition, fax server 28 is configured to communicate with other work stations 38, 40, and 42.

An introductory user interface (not shown) is downloaded from server 12 to be displayed on device 14. The user accesses a product configurator system residing on server 12 through the internet when browsing for or receiving a quote on paralleling switchgear equipment. The user interface (not shown) allows the user to register a login name and password. In addition, if the user is not registered as a customer, the user interface allows one to become registered by providing at least an address, a telephone number, a fax number, an e-mail address, a company name, a company address, describe the type of company, and the user's job function within the company. The user interface, therefore, prevents unauthorized, unregistered users from accessing the product configurator system.

The product configurator system includes computer software residing on Server 12 that customizes a paralleling switchgear system. The product configurator system software resides on server 12 and accesses database 18 for specific manufacturing requirements of a paralleling switchgear system based on user selected specifications. The software can be accessed via the Internet by an approved user. In an exemplary embodiment, data is stored in centralized database 18. Information regarding each customer, as well as information regarding products to configure a parallel switchgear system, are contained in centralized database 18. Of course, data can be stored in many different forms using many different structures, and database 18 illustrates just one form and structure for storing the data.

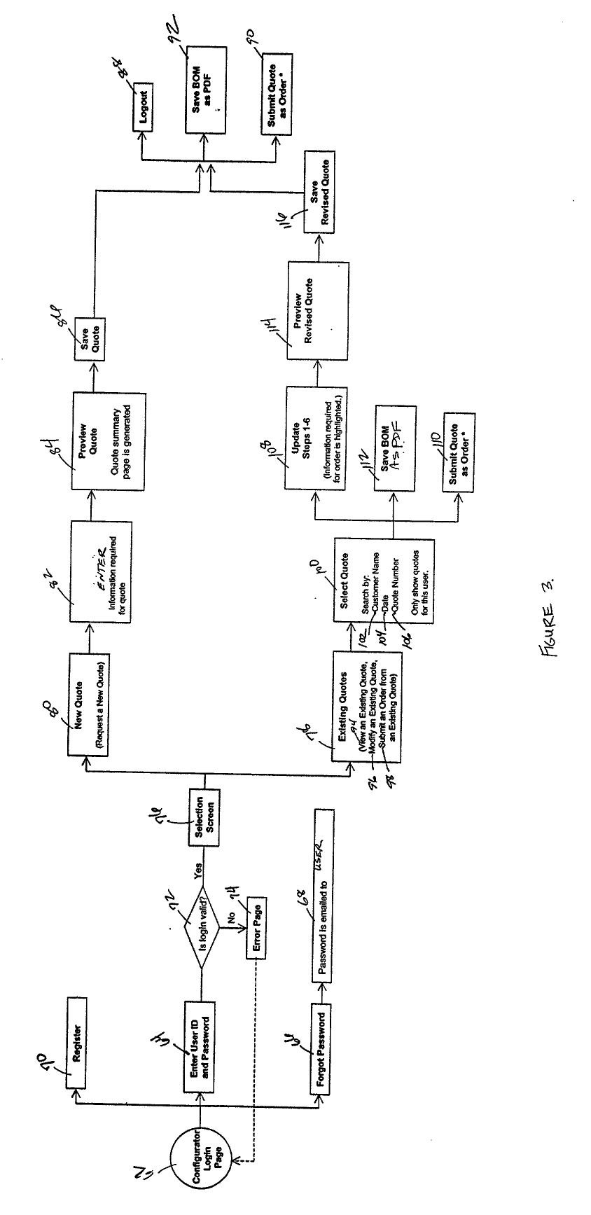

FIG. 3 is a process flow diagram of configurator system 60. A user logs 62 into configurator system 60 by entering a user identification and password 64. If the user has forgotten their password 66, the password will be e-mailed to the user 68, upon proper verification. If the user is not registered to access configurator system 60, they can register 70. If the user enters an invalid password or incorrectly enters the user identification, the login will be invalid 72 and an error page 74 will be displayed. The user will be allowed to re-enter their user identification 64 and password to access configurator system 60. Once the login has been successfully accomplished, a selection screen 76 is displayed from which the user selects to view existing quotes 78 or selects to generate a new quote 80. To generate new quote 80, the user enters information required for a new quote 82 and a quote summary page 84 is generated and displayed for user confirmation. In one embodiment, the user enters information using voice activated commands. The quote is then saved 86 and the user can then logout 88, submit the quote as an order 90, or save a “bill of material” (BOM) as a portable document file (“PDF”) 92.

Alternatively, the user can select to examine existing quotes 78. The user can view an existing quote 94, modify an existing quote 96, or submit an order from an existing quote 98. Configurator system 60 allows the user to select a quote 100 by searching centralized database 18 (shown in FIG. 1) by a customer name 102, a date 104, and a quote number 106. In one embodiment, centralized database 18 provides up-to-date information instantaneously to the user upon request on a real-time basis. Configurator system 60 will only display quotes entered by the user, e.g., the user cannot access quotes from other users. After examining the quote, the user can update quote 108, submit the quote as an order 110, or save a BOM as a PDF 112. In addition to generating quote 108, configurator system 60 generates and displays a bill of material and engineering drawings. The engineering drawings include at least an equipment elevation drawing, an equipment outline drawing, and an electrical schematic. When updating quote 108, configurator system 60 will display a revised quote and then save the revised quote 116. The user can then logout 88, submit the revised quote as an order 90, or save a BOM as a PDF file 92.

### Exemplary Customer Viewable Screen Shots

To implement the process described above, many variations of particular screens viewable by a customer can be utilized. The following description refers to one set of screens that can be used to prompt a customer to make the necessary inputs to enable the system to generate engineering drawings and a quotation. Of course, many variations of such screens are possible.

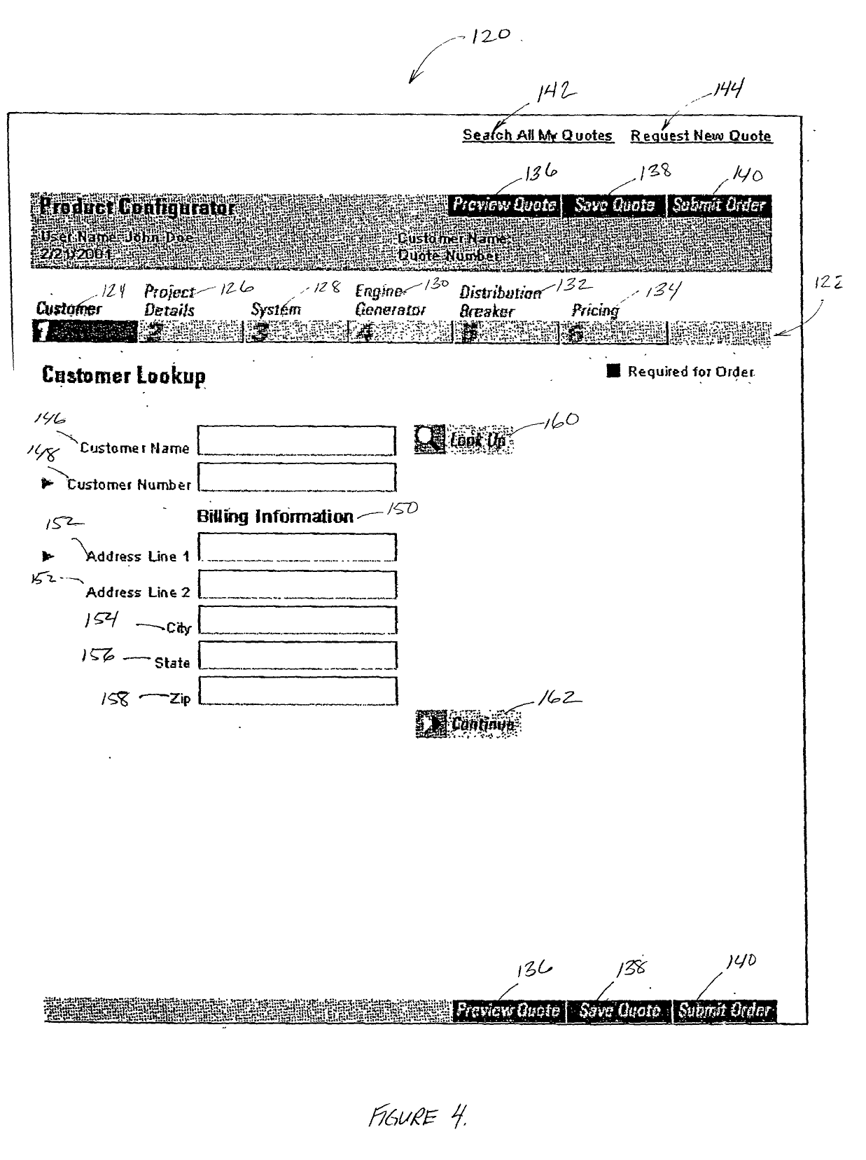

Referring now again specifically to the drawings, FIG. 4 is an exemplary embodiment of a user interface to lookup a customer quotation 120 based on customer information. Customer quotation interface 120 includes a navigator bar 122 that includes a list of other user interfaces that are hyperlinked together, such that, the user can hyperlink from one interface screen to another by selecting one of the choices presented by navigator bar 122. In one embodiment, navigator bar 122 includes a customer lookup interface 124, a project details interface 126, a system interface 128, an engine-generator interface 130, a distribution breaker interface 132, and a pricing interface 134. In addition, customer quotation interface 120 allows the user to preview a quote 136, save a quote 138, and submit an order 140. Furthermore, customer quotation interface 120 permits the user to search all quotes 142 and request a new quote 144.

Customer lookup 120 also includes fields for the user to enter a customer name 146, a customer number 148, and billing information 150 that includes address lines 152, a city 154, a state 156, and a zip code 158. The user can select to examine existing quotes 78 (shown in FIG. 3) by selecting look-up 160. The user can continue entering a new quote 80 (shown in FIG. 3) by selecting continue 162. In addition, the customer can select to preview quote 136 to verify that the information entered is correct. The data displayed by preview quote 136 is pre-stored in centralized database 18 (shown in FIG. 2). The customer can make changes to the data and save the changes. The customer can then exit the site, or perform further transactions by making the appropriate selection on customer lookup interface 120, e.g., select save quote 138 or submit order 140.

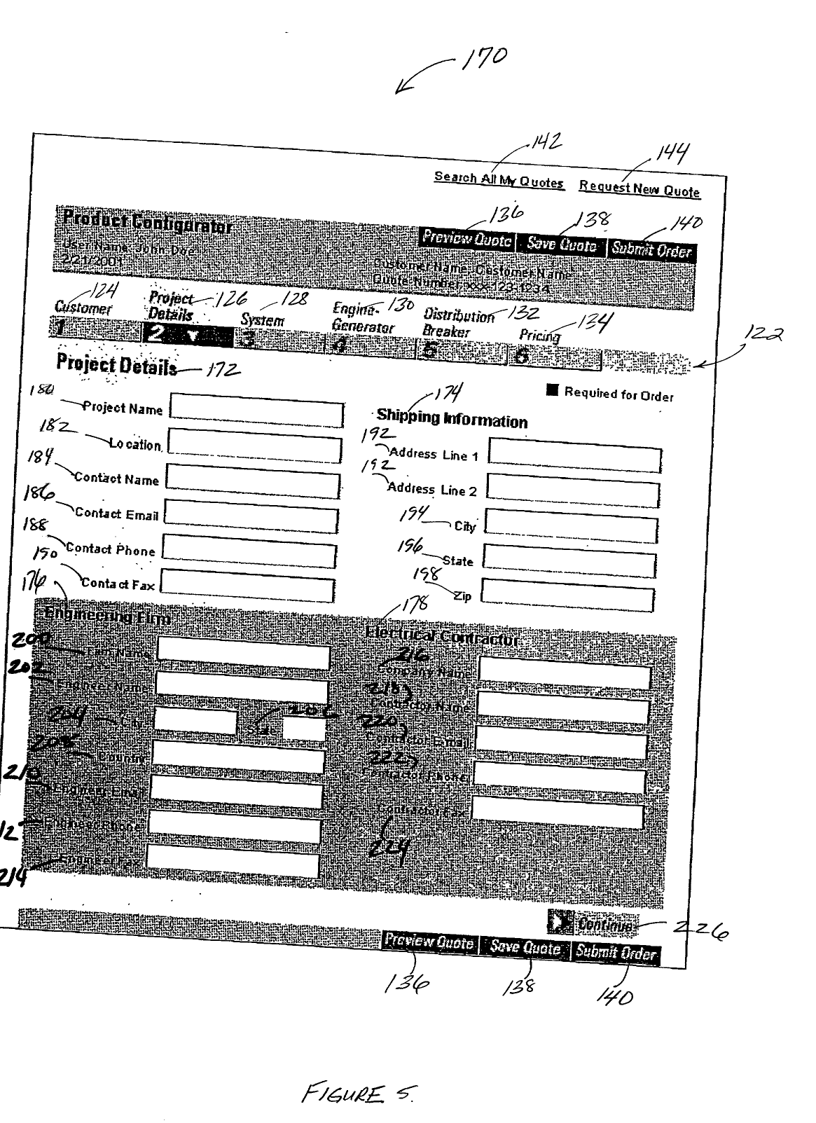

Referring now again specifically to the drawings, FIG. 5 is an exemplary embodiment of a user interface for project contact information 170. Fields in project contact interface 170 that are identical to fields in lookup quotation interface 120 (shown in FIG. 4) are identified in FIG. 5 using the same reference numerals as used in FIG. 4. Project contact interface 170 includes data for project details 172, shipping information 174, engineering firm information 176, and electrical contractor information 178.

Project details 172 includes fields for the user to enter a project name 180, a location 182, a contact name 184, a contact e-mail 186, a contact phone 188, and a contact fax 190. Shipping information 174 includes fields for the user to enter an address 192, a city 194, a state 196, and a zip code 198. The shipping information may be identical to billing information 156 (shown in FIG. 4) depending on the customer. Engineering firm information 176 includes fields for the user to enter a firm name 200, an engineer's name 202, a city 204, a state 206, a country 208, an engineer's e-mail address 210, an engineer's phone number 212, and an engineer's fax number 214. Electrical contractor information 178 includes fields for the user to enter a company name 216, a contractor's name 218, a contractor's email 220, a contractor's phone number 222, a contractor's fax number 224. The user selects continue 226 when the project contact information has been entered. In addition, the customer can select to preview quote 136 to verify that the information entered is correct. The data displayed by preview quote 136 is pre-stored in centralized database 18 (shown in FIG. 2). The customer can make changes to the data and save the changes. The customer can then exit the site, or perform further transactions by making the appropriate selection on project contact interface 170, e.g., select save quote 138 or submit order 140.

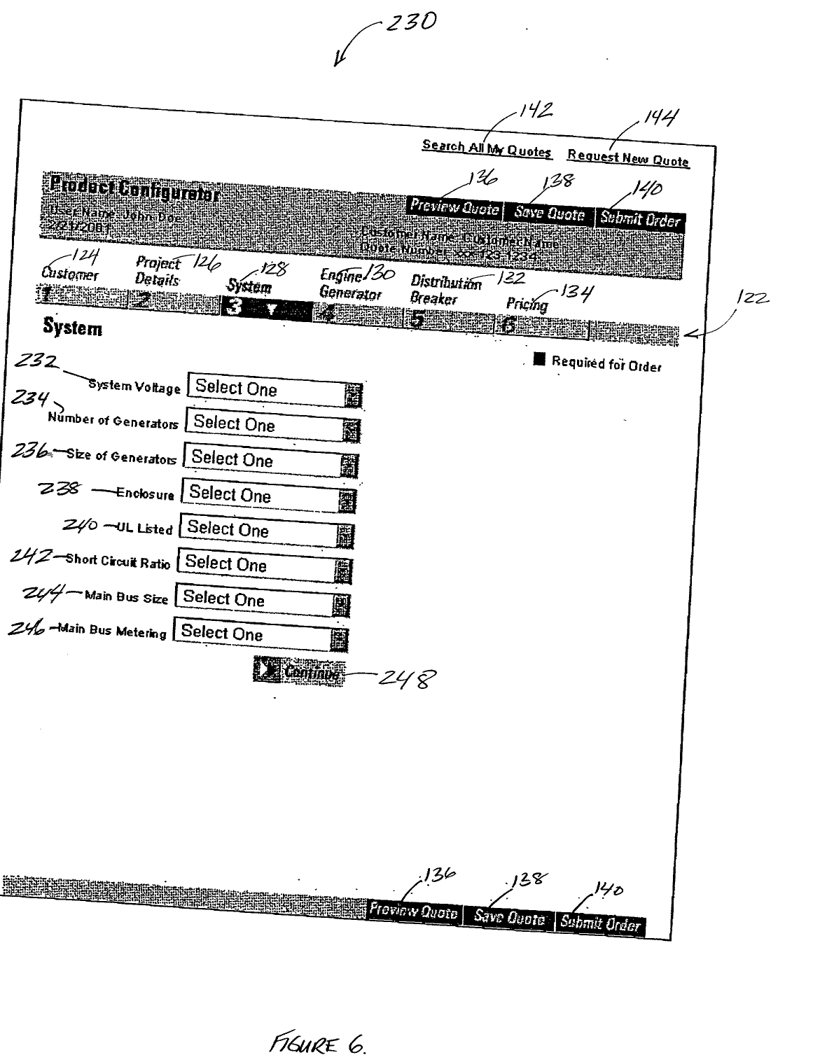

Referring now again specifically to the drawings, FIG. 6 is an exemplary embodiment of a user interface for selecting a paralleling switchgear system configuration 230. Fields in system configuration interface 230 that are identical to fields in lookup quotation interface 120 (shown in FIG. 4) are identified in FIG. 6 using the same reference numerals as used in FIG. 4. To configure a system, the user selects from a plurality of fields having drop-down menus, such as, a system voltage 232, a number of generators 234, a size of generators 236, an enclosure 238, a Underwriter's Laboratory, Inc., (UL®) listing standard 240, a short circuit ratio 242, a main bus size 244, and a main bus metering 246. The user selects continue 248 after system information has been selected. In addition, the customer can select to preview quote 136 to verify that the information entered is correct. The data displayed by preview quote 136 is pre-stored in centralized database 18 (shown in FIG. 2). The customer can make changes to the data and save the changes. The customer can then exit the site, or perform further transactions by making the appropriate selection on system configuration interface 230, e.g., select save quote 138 or submit order 140.

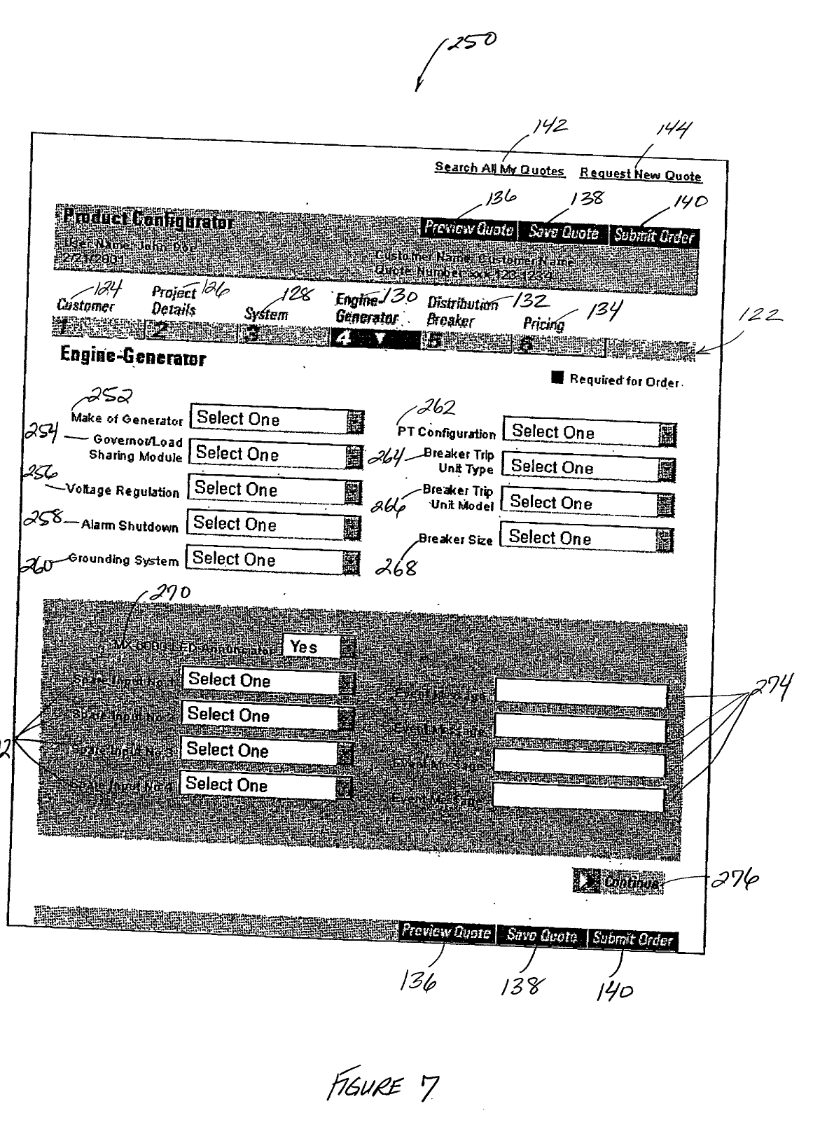

Referring now again specifically to the drawings, FIG. 7 is an exemplary embodiment of a user interface for selecting a configuration of an engine generator 250 for a paralleling switchgear system. Fields in engine generator interface 250 that are identical to fields in lookup quotation interface 120 (shown in FIG. 4) are identified in FIG. 7 using the same reference numerals as used in FIG. 4. To configure the engine generator information, the user selects from a plurality of fields having drop down menus, such as, a make of generator 252, a governor/load sharing module type 254, a voltage regulator type 256, an alarm shutdown 258, a grounding system 260, a “potential transformer” (PT) configuration 262, a breaker trip unit type 264, a breaker trip unit model 266, a breaker size 268, an annunciation unit type 270, and a plurality of spare inputs 272, each with its own event message 274. The user selects continue 276 after the engine-generator has been configured. In addition, the customer can select to preview quote 136 to verify that the information entered is correct. The data displayed by preview quote 136 is pre-stored in centralized database 18 (shown in FIG. 2). The customer can make changes to the data and save the changes. The customer can then exit the site, or perform further transactions by making the appropriate selection on engine generator interface 250, e.g., select save quote 138 or submit order 140.

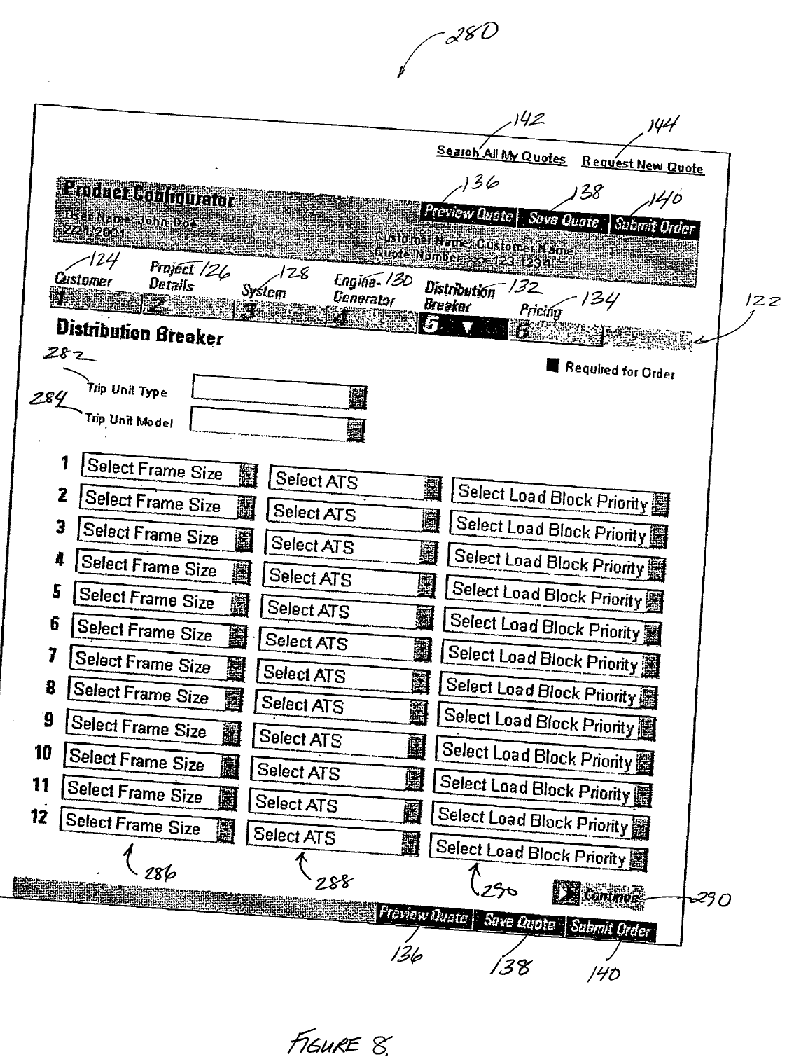

Referring now again specifically to the drawings, FIG. 8 is an exemplary embodiment of a user interface for configuring a plurality of distribution breakers 280 for a paralleling switchgear system. Fields in distribution breaker interface 280 that are identical to fields in lookup quotation interface 120 (shown in FIG. 4) are identified in FIG. 8 using the same reference numerals as used in FIG. 4. To select a distribution breaker, the user selects from pull down menus a trip unit type 282 and a trip unit model 284. In addition, the user can select up to twelve configurations for a frame size 286, an automatic transfer switch (ATS) 288, and a load block priority 290. The user selects continue 292 after the distribution breaker has been configured. In addition, the customer can select to preview quote 136 to verify that the information entered is correct. The data displayed by preview quote 136 is pre-stored in centralized database 18 (shown in FIG. 2). The customer can make changes to the data and save the changes. The customer can then exit the site, or perform further transactions by making the appropriate selection on distribution breaker interface 280, e.g., select save quote 138 or submit order 140.

Therefore, a network based method for a user to automatically configure and order a paralleling switch gear system, develop a bill of material, generate engineering drawings, provide a price quotation, and store the configuration in a central database is provided.

While the invention has been described in terms of various specific embodiments, those skilled in the art will recognize that the invention can be practiced with modification within the spirit and scope of the claims.

What is claimed is:

1. A method for automatically customizing and specifying a parallel switchgear system using a computer network-based system including a server coupled to a centralized database and at least one client system, said method comprising the steps of:
accessing a product configurator system;
selecting switchgear product configurations from a plurality of user interfaces; and
receiving at least one of a bill of material, a drawing and a price quotation for a parallel switchgear system.

2. A method according to claim 1 wherein said step of registering further comprises the step of utilizing a plurality of graphical user interfaces to enter at least one of billing information, project information, shipping information, engineering firm information, and electrical contractor information.

3. A method according to claim 1 wherein said step of accessing a product configuration system further comprises the step of accessing the database to lookup at least one of a customer information, a project's details, a system, an engine generator, and a distribution breaker.

4. A method according to claim 1 wherein said step of selecting switchgear product configurations further comprises the step of the user using a graphical user interface to select at least one of a system configuration, an engine generator configuration, and a distribution breaker configuration.

5. A method according to claim 4 wherein said step of selecting switchgear product configurations comprises the steps of:
using the client system to select various switchgear configurations through pull-down menus; and
submitting the selections to the server.

6. A method according to claim 5 wherein said step of selecting switchgear various configurations comprises the step of using the system pull-down menu to select a switchgear system configuration, wherein the switchgear system configuration comprises at least one of a system voltage, a number of generators, a size of generators, an enclosure, a laboratory tested listing, a short circuit rating, a main bus size, and a main bus metering.

7. A method according to claim 5 wherein said step of selecting switchgear various configurations comprises the step of using the system pull-down menu to select an engine generator configuration, wherein the engine generator configuration comprises at least one of a make of generator, governor/load sharing module, a voltage regulation, an alarm shutdown, a grounding system, a PT configuration, a breaker trip unit type, a breaker trip unit model, a breaker size, an annunciation unit type, and a plurality of spare inputs.

8. A method according to claim 5 wherein said step of selecting switchgear various configurations comprises the step of using the system pull-down menu to select a distribution breaker configuration, wherein the breaker distribution configuration comprises at least one of a trip unit type, a trip unit model, a frame size, an automatic transfer switch, and a load block priority.

9. A method according to claim 1 wherein said step of receiving drawings further comprises the step of generating at least one of an equipment elevation drawing, an equipment outline drawing, and an electrical schematic.

10. A method according to claim 1 wherein said step of receiving a quote further comprises the step of submitting an order to the server.

11. A method according to claim 1 wherein said step of receiving a quotation further comprises the steps of:
displaying quotation data; and
printing the quotation on a printer.

12. A method according to claim 11 wherein said step of displaying a quotation further comprises the steps of:
displaying a delivery schedule;
displaying methods of confirmation;
displaying a transaction number; and
displaying customer information.

13. A method according to claim 12 wherein said step of displaying a quotation further includes the step of displaying at least one of an HTML document and a XML document on the client system downloaded by the server system.

14. A method according to claim 1 wherein the client system and the server system are connected via a network and wherein the network is at least one of a wide area network, a local area network, an intranet, and the Internet.

15. A system for customizing and specifying a parallel switchgear system, said system comprising:
a device;
a computer server connected to said device via a computer network and configured to receive user specifications and selected configurations; and
a product configurator system configured to receive user specifications and user selected configurations, said system further configured to generate at least one of a drawing and a quotation.

16. A system according to claim 15 wherein the computer network is at least one of a wide area network, a local area network and the Internet.

17. A system according to claim 15 wherein said device is configured to be a client system for a network of customer devices.

18. A system in accordance with claim 15 wherein said device configured as a client system comprising a browser.

19. A system in accordance with claim 18 wherein said server system configured to be coupled to said client system and a database, said server system further configured to:
display on the client system pull-down menus to configure a parallel switchgear system;
accept a user's selection of various pre-determined components of a parallel switchgear system;
store the user's selections; and
generate drawings and a price quotation for a parallel switchgear system.

20. A system according to claim 15 wherein said server further configured to:
determine whether the features selected are available for the selected product configuration; and
display a warning for user selected non-recommended configurations.

21. A system according to claim 15 wherein said server system further configured to display at least one of an HTML document and an XML document downloaded by said server system.

22. A system according to claim 18 wherein said client system is further configured with:
a sending component to send an inquiry to the server system so that the server system can process and download the requested information to the client system.

23. A system according to claim 22 wherein said server system further configured to:
access the centralized database;
search the database regarding the specific inquiry;
retrieve information from the database; and
transmit the retrieved information to the client system for display by the client system.

24. A system according to claim 15 wherein said product configurator system comprises a plurality of graphical user interfaces for a user to enter at least one of registration information, billing information, project information, shipping information, engineering firm information, and electrical contractor information.

25. A system according to claim 15 wherein said product configurator system further comprises a plurality of graphical user interfaces to configure at least one of a system, an engine-generator, and a distribution breaker.

26. A system according to claim 25 wherein said product configurator system user interface comprises a user interface to select at least one of a system voltage, a number of generators, a size of generators, an enclosure, a laboratory tested listing, a short circuit ratio, a main bus size, and a main bus metering.

27. A system according to claim 25 wherein said product configurator engine generator user interface comprises a user interface to select at least one of a comprises at least one of a make of generator, governor/load sharing module, a voltage regulator, an alarm shutdown, a grounding system, a potential transformer configuration, a breaker trip unit type, a breaker trip unit model, a breaker size, an annunciation unit type, and a plurality of spare inputs.

28. A system according to claim 25 wherein said product configurator distribution breaker user interface comprises a user interface to select at least one of a trip unit type, a trip unit model, a frame size, an automatic transfer switch, and a load block priority.

29. A system according to claim 15 wherein said product configurator system further configured to generate at least one of a bill of material, an equipment elevation drawing, an equipment outline drawing, and an electrical schematic.

30. A database comprising:
data corresponding to parallel switchgear equipment; and
data corresponding to a user desired parallel switchgear system configuration.

31. A database according to claim 30 further comprising data corresponding to at least one of a plurality of system configurations, a plurality of engine generator configurations, a plurality of distribution breaker configurations, and associated pricing for the various configurations.

32. A computer-readable medium, comprising:
a record of customer submitted parallel switchgear system configurations;
a plurality of rules for matching parallel switchgear equipment to customer submitted selections for a particular configuration of a system; and
a record of results from applying the matching rules to the customer submitted selections.

33. A computer-readable medium according to claim 32 wherein said record of parallel switchgear configurations comprise records of at least one of a system configuration, an engine generator configuration, and a distribution breaker configuration.

34. A computer readable medium according to claim 33 wherein said system configuration comprises at least one of a system voltage, a number of generators, a size of generators, an enclosure, a laboratory tested listing, a short circuit ratio, a main bus size, and a main bus metering.

35. A computer readable medium according to claim 33 wherein said engine generator configuration comprises at least one of a make of generator, governor/load sharing module, a voltage regulation, an alarm shutdown, a grounding system, a potential transformer configuration, a breaker trip unit type, a breaker trip unit model, a breaker size, an annunciation unit type, and a plurality of spare inputs.

36. A computer readable medium according to claim 33 wherein said distribution breaker configuration comprises at least one of a trip unit type, a trip unit model, a frame size, an automatic transfer switch, and a load block priority.

37. A computer-readable medium according to claim 32 wherein said record of results comprises at least one record of a bill of material, a drawing, and a quotation for a parallel switchgear system.

38. A computer-readable medium according to claim 37 wherein said drawings comprise a record of at least one of an equipment elevation drawing, an equipment outline drawing, and an electrical schematic.

39. A computer program embodied on a computer readable medium connected to a server coupled to a centralized database and at least one client system via a network, said computer program for configuring a parallel switchgear system, comprising:
a code segment that receives user registration information;
a code segment that displays a graphic user interface for the user to select a parallel switchgear system configuration;
a code segment that receives the user selections;
a code segment that stores the selections into a centralized database;
a code segment that cross-references the selections against a unique identifier; and
a code segment that provides at least a drawing and a quotation.

40. A computer program as recited in claim 39 further includes a code segment that:
tracks information on a real time basis; and
stores information on a real time basis by updating stored information in the centralized database by adding new information to the centralized database on a real-time basis to provide up-to-date information instantaneously to the user upon a request.

41. The computer program as in claim 39 further includes a code segment that displays a graphical user interface for the user to utilize to select a configuration for the parallel switchgear system.

42. The computer program as recited in claim 41 further includes a code segment that displays information through an HTML document downloaded by the server system.

43. The computer program as in claim 41 wherein the selections received from the graphical user interface are stored in at least the server and the centralized database.

44. A computer program as recited in claim 39 further includes:
a code segment that accesses the centralized database;
a code segment that retrieves information from the database; and
a code segment that causes the retrieved information to be displayed on the client system.

45. A computer program as recited in claim 39 further includes a code segment that monitors the security of the system by restricting access to unauthorized individuals.

46. The computer program as in claim 39 wherein the network is a wide area network operable using a protocol including at least one of TCP/IP and IPX.

47. The computer program as recited in claim 39 wherein the client system and the server system are connected via said network and wherein said network is at least one of a wide area network, a local area network, an internet and the Internet.
